(19) United States
(12) Patent Application Publication
(10) Pub. No.: US 2024/0305864 A1
(43) Pub. Date: Sep. 12, 2024

(54) MEDIA SHARING AND COMMUNICATION SYSTEM

(71) Applicant: David A. TAYLOR, Sterling Heights, MI (US)

(72) Inventor: David A. TAYLOR, Sterling Heights, MI (US)

(21) Appl. No.: 18/669,817

(22) Filed: May 21, 2024

Related U.S. Application Data
(63) Continuation-in-part of application No. 18/652,119, filed on May 1, 2024.
Application No. 18/652,119 is a continuation-in-part of application No. 17/947,336, filed on Sep. 19, 2022.
Application No. 17/947,336 is a continuation-in-part of application No. 17/108,306, filed on Dec. 1, 2020, now Pat. No. 11,457,284.
Application No. 17/108,306 is a continuation-in-part of application No. 17/087,794, filed on Nov. 3, 2020, now Pat. No. 11,456,982.
Application No. 17/087,794 is a continuation-in-part of application No. 16/923,699, filed on Jul. 8, 2020, now Pat. No. 11,483,624.
Application No. 16/923,699 is a continuation-in-part of application No. 16/882,512, filed on May 24, 2020, now Pat. No. 11,483,432.
Application No. 16/882,512 is a continuation-in-part of application No. 16/832,370, filed on Mar. 27, 2020, now Pat. No. 11,582,526.
Application No. 16/832,370 is a continuation-in-part of application No. 16/683,347, filed on Nov. 14, 2019, now Pat. No. 10,715,872.
Application No. 16/683,347 is a continuation-in-part of application No. 16/032,612, filed on Jul. 11, 2018, now Pat. No. 10,694,255.
Application No. 16/032,612 is a continuation-in-part of application No. 13/937,001, filed on Jul. 8, 2013, now Pat. No. 10,368,122.
(60) Provisional application No. 61/773,518, filed on Mar. 6, 2013.

(51) Int. Cl. H04N 21/478; H04N 21/414; H04N 21/44; H04N 21/472

(52) U.S. Cl. CPC H04N 21/47815; H04N 21/41407; H04N 21/44008; H04N 21/472

(57) ABSTRACT

A shopping interface for purchasing items on media, including a user system having a user interface displaying items for purchase that is accessible through a user initiating a connection between a mobile device and a media screen that pushes data of items for purchase or available bets to the mobile device, wherein the user interface is remote from the media being shown, the user system including software stored on non-transitory computer readable media that recognizes and tags purchasable items in the media, wherein the user system displays items for purchase, the user system including a one-click purchase function allowing for secure and efficient purchases. A method of shopping on media. A method of shopping and promoting products on media.

### BACKGROUND OF THE INVENTION

### 1. Technical Field

The present invention relates to generally to media sharing and communication systems and methods of providing the same.

### 2. Background Art

Individuals having common bonds, both men and women, congregate together to watch events such as sports, theater, or otherwise. In one particular aspect, it is common for individuals to watch television programming including movies, sports, politics, or otherwise. This may occur in a public setting, such as bars, or in a private setting, such as one's home. During these programming events, individuals engage in discussions, exchange of ideas or beliefs, cheering or even badgering one another.

With the expansion in relationships between individuals, it is not always possible for individuals to participate in viewing events or programming together. This is particularly the case after individuals separate over time, such as after military service, college, or otherwise. However, recently it has become more common for individuals to maintain long distance relationships with one another. To this extent, various internet service providers have offered networking and communication systems between individuals. They provide the ability to send public and private messages to others in their networking group. They also provide the ability to share profiles and preferences with one another so as to exchange information. Examples of such networking systems include FACEBOOK®, LINKEDIN®, TWITTER®, or otherwise.

However, while these and other networking means have provided some means for individuals to maintain contact, they do not effectively replace the ability for individuals to interact with one another, particularly when it comes to events and more particularly with television programming.

In view of the foregoing, there is a need for systems and methods to allow individuals to continue to enjoy events and programming together, without having to be at the same location. This allows for expanded networking in different aspects than before.

### SUMMARY OF THE INVENTION

The present invention provides for a shopping interface for purchasing items on media, including a user system having a user interface displaying items for purchase that is accessible through a user initiating a connection between a mobile device and a media screen that pushes data of items for purchase or available bets to the mobile device, wherein the user interface is remote from the media being shown, the user system including software stored on non-transitory computer readable media that recognizes and tags purchasable items in the media, wherein the user system displays items for purchase, the user system including a one-click purchase function allowing for secure and efficient purchases.

The present invention also provides for a method of shopping on media, including the steps of a user initiating a connection between a mobile device of a user system having a user interface and a media screen that pushes data of items for purchase or available bets to the mobile device, wherein the user interface is remote from the media being shown, software recognizing and assigning functional tags to purchasable items in the media, the functional tags not being visually displayed on a screen during media playback, the user selecting an item in the media by clicking on it, the user accessing a one-click purchase function on the screen, and the user purchasing the item seamlessly.

The present invention also provides for a method of shopping and promoting products on media, by a user playing media and accessing a store section on a user system having a user interface, software recognizing and assigning functional tags to purchasable items in the media, the functional tags not being visually displayed on a screen during media playback, the items being promoted by a company that is partnered with the user system instead of a competitor, the user selecting an item in the media for purchase, the user accessing a one-click purchase function in the user interface, and the user purchasing the item seamlessly.

### DESCRIPTION OF THE DRAWINGS

Other advantages of the present invention are readily appreciated as the same becomes better understood by reference to the following detailed description when considered in connection with the accompanying drawings wherein:

FIG. 1 illustrate a schematic view of a media sharing and communication system according to the teachings of the present invention;

FIG. 2 illustrates a schematic view of another media sharing and communication system according to the teachings of the present invention;

FIG. 3 illustrates a schematic view of another media sharing and communication system according to the teachings of the present invention;

FIG. 4 illustrates a schematic view of another media sharing and communication system according to the teachings of the present invention;

FIG. 5 illustrates a screen-shot of an exemplary user interface according to the teachings of the present invention;

FIG. 6 is a diagram of the system architecture; and

FIGS. 7A-71 show screenshots of product recognition within the store section, FIG. 7A shows an outfit, FIG. 7B shows recognition of pieces of an outfit, FIG. 7C shows a coat, FIG. 7D shows a bag, FIG. 7E shows a shoe, FIG. 7F shows a shoe, FIG. 7G shows products found in the image of FIG. 7H, and FIG. 7I shows suggested products.

### DETAILED DESCRIPTION OF THE INVENTION

The present invention generally provides systems and methods for sharing and exchanging media between individuals as well as shopping on media with a media sharing and communication system 10, shown in the FIGURES. The exchange of media can be based on known interests of others.

“Individual” as defined herein, refers to an individual user of media, and not a media content provider or company.

“Media” as used herein, refers preferably to a short portion of media, or a clip i.e., less than a whole video, movie, television show, song, commercial, etc. However, full portions of media can also be shared. Also, screenshots of media can be shared. The portion of media can be any length of time, such as 5 seconds, 10 seconds, 25 seconds, 1 minute, 2 minutes, 5 minutes, or other lengths. Some media are already divided into blocks defining particular scenes, such as in 10 second blocks or other lengths. The preset blocks of media can also be shared, and do not necessarily need to be recorded to be shared.

The media can also be an online game, and users can record portions of the game they are playing, allowing other users to see highlights, records, achievements, or in general plays they have made. The online game can be played on systems such as Xbox, PlayStation, Nintendo DS, or other web-based games through the Internet.

Advancements through the features of the present invention provide a TUBEMAIL™, TUBESHARE™, YOUSHARE™, communication system that allows individual users, who share the same cable or satellite provider, the ability to record and share portions or full episodes of sporting events, movies, shows, or otherwise along with messages regarding the media.

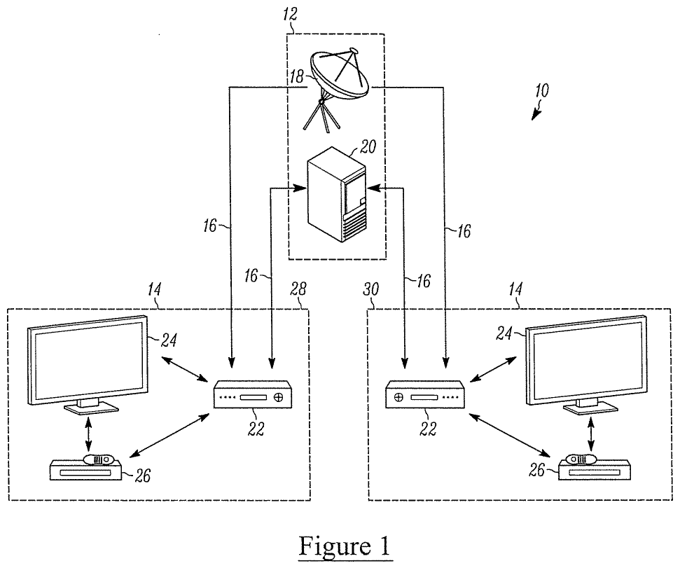

Referring to FIG. 1, an exemplary embodiment of a media sharing and communication system 10 is shown. The system 10 includes a media content provider 12 configured to provide media content to a plurality of user systems 14 over one or more networks 16. The system 10 includes a transmitter 18 configured to transmit media, particularly media programming, to the user systems 14 over the one or more networks 16. The system 10 further includes a receiver 20 configured to receive media, or media information including identification information, from the user systems 14, over the one or more networks 16. The plurality of user systems 14 are configured to receive media, such as television programming, from the media content provider 12. In one exemplary embodiment, the user systems 14 include a user transmitter/receiver 22, in communication with the media content provider, a display screen 24 for viewing media content received by the user transmitter/receiver, and in one particular exemplary embodiment a digital recording device 26 for recording digital information received by the transmitter/receiver 18. In one particular configuration, the user transmitter/receiver 22 is further configured for transmitting data stored by the digital recording device 26.

In one exemplary mode of operation, digital media is transmitted or streamed by the media content provider 12 to the plurality of user systems 14. The media transmitted by the media content provider 12 may comprise any media transmitted by a network including programming shows, movies, sporting events, or otherwise. The transmitted media is received by the user systems 14 through the one or more networks 16. The media received by the user transmitter/receiver 22 is further transmitted to the display screen 24 for viewing. During viewing, once the individual user of the user system 14 determines they wish to share media content, the digital recording device 26 is activated to record the desired media or record information pertaining to the desired media. The media can also be stored and saved on non-transitory computer readable medium on the digital recording device 26 for sharing at a later time by the user or for the user's own personal reasons such as rewatching media or posting to their profile or social media to promote dialogues about certain scenes or products. The digital recording device 26 can also copy the media for storage for a limited time instead of recording. The individual user of the user system 14 generates a message (which can be a text message, a voice commentary message, information related to the location of the media, or combinations thereof) and the recorded media or record information pertaining to the desired media along with the message is then transmitted to another user system 14 (i.e., a second user system 14), via the network 16, through the user transmitter/receiver 22. It should be understood that text messages can include emojis. Messages can also include image files, such as memes, gifs, stickers, or other files. Dissemination of media from one user system 14 to another user system 14 may be based upon selection by an individual user of the first user system 14, based upon user profile set up by an individual user of the first or second user system 14, or otherwise. In other words, the media can be selectively distributed to individual users based on their preferences, including an indication of desired media content. Once the recorded media or media information is received by the second user system 14, the second individual user selectively reviews the message and views the media. In case the first individual user does not send a message along with the portion of media, the second individual user can initiate dialogue with the first individual user and send a message to the first individual user. For example, if the first individual user sends a clip from a TV show without a message, and the second individual user is confused as to why they received the clip, they can send a message to the first individual user to ask them why the clip was sent. The first individual user can send messages either to a second individual user alone, or to a group of individual users that the first individual user can select to share the message with. When sent to a group, this functions as a group chat.

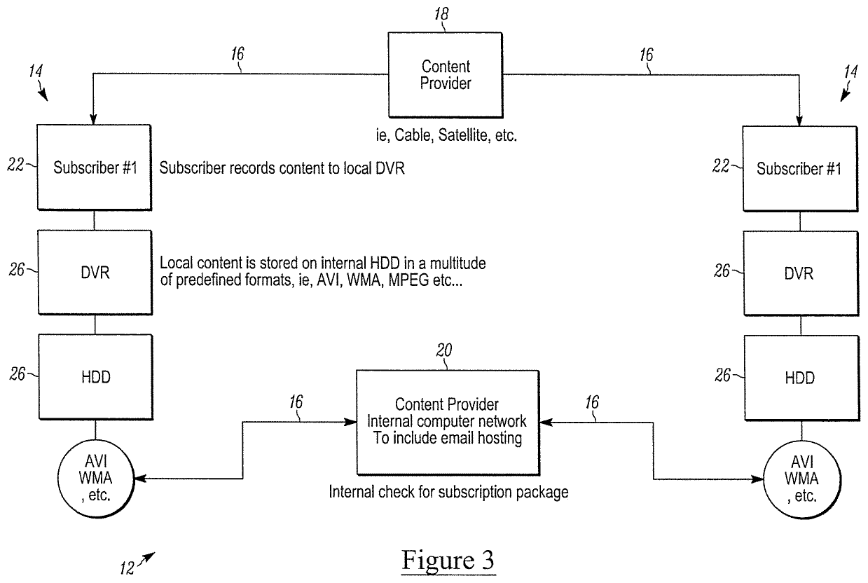

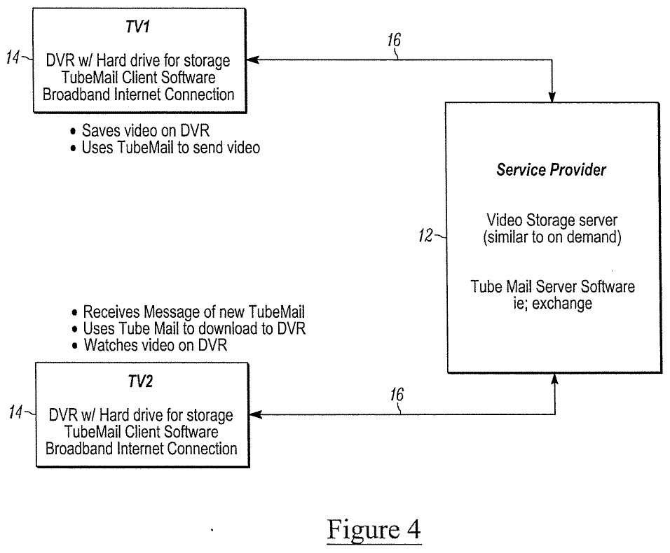

In greater detail, with reference to FIGS. 1-4, the media content provider 12 is configured for disseminating media to a plurality of user systems 14. In one exemplary embodiment, the media content provider 12 comprises a cable television provider, satellite television provider, online movie or other media provider, a media provider through applications on a smartphone or tablet, computer, or otherwise. The media content provider 12 provides assortment of media including audio/visual media, identification information or otherwise. The media provides one or more, or plurality of programming for the user systems 14. Examples of programming available through the media, without limitation, includes movies, network programming, sporting events, concerts, online games, or otherwise. The media disseminated to the user systems 14 may be streamed through or stored on local hard drive of the media content provider 12 or be accessible through a cloud.

The transmitter 18 of the media content provider 12 is configured to disseminate media to a plurality of user systems 14 over one or more networks 16. In one configuration, the network comprises a hardwired network, such as a cable network extending from the media content provider 12 to the user systems 14. In another configuration, the network comprises or includes a wireless network configured for broadcasting signals through radio waves or otherwise. In the latter configuration the media content provider 12 includes a satellite dish or other means for broadcasting media. It is contemplated that the media disseminated from the media content provider 12 may be streamed through the media content provider or stored on one or more digital recording device. Any user transmitter 18 or receiver 20 can include wireless communication links for receiving media and media content providers 12 can disseminate media through wireless communication links.

The receiver 20 of the media content provider is configured to receive information from the user systems 14. In one configuration, the receiver 20 records data transmitted by the user systems including media, program information, both or otherwise. Accordingly, in view of the many potential user systems 14, it is contemplated that the receiver 20 includes many data storage devices. In another configuration, the receiver 20 is further configured for transmitting the received or recorded media to another user system 14, according to a request by the originating user system 14.

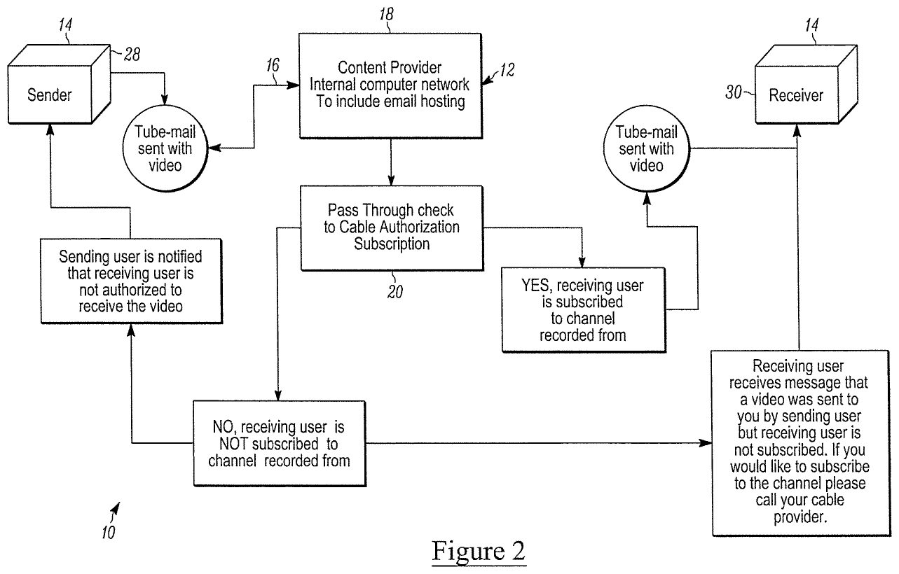

In one particular exemplary embodiment, referring to FIG. 2, the receiver 20 is configured with suitable software for reviewing media transmitted by a user system. In this configuration, it is possible for the receiver 20 to review the identification information of the media transmitted by a first user system 28 and confirm that a designated second user system 30 is authorized to receive the media. In this configuration, the receiver 20 confirms that the media transmitted by the first user system 28 is viewable by the second user system 30 through the viewing package held by the second user system. For example, should the first user system 28 transmit media from a first channel the receiver 20 confirms that the second user system 30 is authorized to view media on the first channel. Should the programming subscribed by the second user system 30 include the first channel then the second user system is authorized to receive and view the media along with any communication attached therewith. Should the programming purchased by the second user system 30 not include the first channel then the second user system is notified that media could not be received due to programming configuration subscribed by the second user. Also, the first user system 28 is notified that the second user system 30 is not authorized to receive the media due to programming subscription of the second user system. The authorization of the second user system 30 can also be automatic or not needed if all users are subscribed to a particular streaming service or channel that automatically allows them access to content therein.

Referring again to FIG. 1, the user system 14, e.g., first user system 28, second user system 30 or otherwise, include the user transmitter/receiver 22, which is configured to receive media from the media content provider 12 and in one particular exemplary embodiment transmit media and/or communication to the media content provider 12 and another user system 14. In one exemplary embodiment, the user transmitter/receiver 22 is similar or includes a cable box, satellite receiver or similar devise commonly used to receive broadcasted digital programming. It should be appreciated that the transmitter/receiver 22 may comprise a single unit or several units. The user transmitter/receiver 22 can also be a suitable mechanism for receiving data within a smartphone or tablet.

The user system 14 further include display screen 24 configured to display media received by the user transmitter/receiver 22. The display screen comprises any suitable display screen including standard definition televisions, high definition televisions, monitors or otherwise. The display screen 24 is in communication with the transmitter/receiver 22 through suitable connecting cables or otherwise. The user systems 14 further includes digital recording device 26 configured to record media received by the user transmitter/receiver 22. Examples of suitable digital recording devices 26 includes DVRs or otherwise. The digital recording device 26 is in communication with the transmitter/receiver 22 through suitable connecting cables or otherwise.

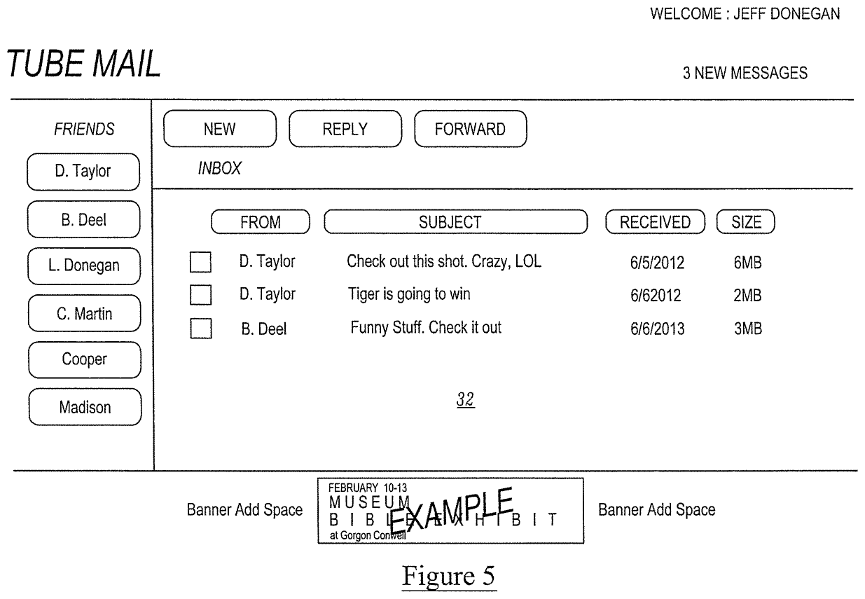

Referring to FIGS. 1 and 5, the user systems 14 further include suitable software for generation of a user interface 32 that is useable with a remote keypad, mouse and/or other user interface devices (i.e., smart/mobile devices, smartphones, tablets, or other portable devices). A smartphone or tablet can also be used as a remote control (to allow for easier messaging and use of emojis and general use of the user interface 32) in combination with a television or larger computer screen such as through the use of BLUETOOTH® or Wi-Fi or through the use of near field communication (NFC) technology. Most generally, the user initiates a connection between a mobile device and a media screen or place showing items for purchase/bets for placing. With NFC, a smart/mobile device can be held within range of a television or other media display screen (approximately 10 centimeters or less) and allows radio communication at a frequency of 13.56 MHz between the smartphone and media display screen. Both the smart device and media display screen can be active devices in order to transmit and receive data. A smart device can be tapped to a media screen with NFC technology to pair with the media screen, i.e., an NFC connection can be initiated between the mobile device and a media screen. This allows the user system 14 to be used in public places showing media such as in a bar and provides full functionality of the user system 14 with various options such as shopping and betting as further described below. The user system 14 can also be used with any remote device (including smartphones) having an optical mechanism (such as an infrared light emitter, or a white light emitter, or photo diodes) that can recognize that certain areas of the screen are targets for performing a function (messaging, shopping, betting, etc.). This can be useful when a user is in a bar or public location and wants to purchase/bet from a media broadcast (further described below). In one exemplary embodiment, the suitable software for generating the user interface 32 is stored on a memory device of the user transmitter/receiver 22. In the configuration shown in FIG. 5, the user interface 32 provides means for composing messages (whether text, video, or voice) and attaching media segments, e.g., audio, video and/or identification information, to the composed message. A quick share button can be included in the user interface 32 that provides instant recording of media with options of length of time of 5 seconds, 10 seconds, 15 seconds, 30 seconds, 1 minute, 5 minutes, as well as any other desired length of time. The completed communication is then sendable to other user systems 14. An instant messaging exchange can be located across the bottom of the user interface 32. In the configuration shown, the user interface 32 includes a ‘FRIENDS’ section indicating users of other user systems 14. The user interface 32 further includes ‘NEW’, ‘REPLY’ and ‘FORWARD’ icons for creating, responding and forwarding communications, which may include media. The user interface 32 further includes ‘INBOX’ section listing communication received from other user systems 14 including ‘FROM’, communication or media ‘SUBJECT’, date ‘RECIEVED’, and file ‘SIZE’ In one exemplary embodiment, the user interface 32 includes ‘Banner Add Space’ for displaying relevant marketing or advertising to the user of the user system, which may be based upon a user profile (including age, gender, location, interests such as favorite television shows, actresses or actors, sport teams, soap operas, musician, band, celebrity commercials or otherwise), transmitted or received media and/or communication, or otherwise.

The user interface 32 can also include a store section wherein users can shop for products or services directly from their user system 14 seamlessly while interacting with media. The store section can be easily accessible through a shop button or icon on the user interface 32, or through texting a code or scanning a QR code with a mobile device (smartphone, tablet, or other device), by pointing a smart device at a screen playing media that has BLUETOOTH® or Wi-Fi capabilities, or by placing a smart/mobile device within range of a media screen with NFC technology (i.e. initiating connection between the smart/mobile device and media screen with NFC technology such as by tapping or pairing a smart/mobile device to a media screen), further described below. The shop button or icon can remain on the screen of the user interface 32 at all times that can be toggled by the user to shop while the media is playing or alternatively the shop button or icon can pop up on the screen when the media is paused. For example, when the media is an online game, the user can toggle purchasing by pausing the game or toggling a purchasing icon on the screen that pauses the game, or alternatively the game can run in the background while a purchase is quickly and seamlessly made with one-click purchasing. A banner or separate section can also run along the bottom of the user interface 32 or at the side where products or services can be displayed while playing media. The store section can include products/services that are directly advertised to the user as above, or products that may be of interest to the user based on their user profile (i.e., targeted to the user based on things that they like or are following their profile). The store section can include links to products/services on outside websites, such that when the user clicks on the item, they are directed to an outside website to complete the purchase. The store section can also receive meta data (or other data tagged with information) from media that the user is watching that generates links to products shown in the media so that the user can purchase the products. The media can automatically push this data to the user system 14. Items can be tagged with a software program similar to facial recognition software used by FACEBOOK®. Any item within the media can be recognized with the software program and identified as an item available for purchase (such as clothing, jewelry, furniture, décor, makeup and beauty items, toys, and other household items) and that item can be located on a website or store for purchase and the price of the item can be identified. The software program can analyze images within the media for pixel values and gradients to compare to images of items available for sale in order to correctly identify the items. It should be understood that the tags are functional and are not visually displayed on a screen during media playback, but rather function as markers, facilitating subsequent actions by the user. The images of items can be tagged with URLs and the user can click on the tag and be directed to a shop to purchase the item. Any of the functions described for the store section can also apply for the more specific betting modules or food ordering modules described below.

Purchasable items can be identified with a logo or icon near the item (which can pop up when a mouse/remote control is moved over the item), or a highlight around the item. The store section can generate a QR code on the user interface 32 that can be scanned by the user's mobile device to show items available for purchase in the media. The QR code can be located anywhere suitable on the user interface 32, such as in a corner of the media playing on a banner or bar, or it can be generated when the media is paused. The user can purchase products linked with the QR code directly on their mobile device (such as a smartphone or tablet).

The store section can also allow for users to purchase songs/music that they hear on media and songs can be tagged in the same manner as physical products. The songs can be downloaded individually as mp3 files or other audio files, or the user can purchase an entire album that the song is from. The songs can be synced or downloaded directly to the user's account or to other music platforms such as Apple Music or TIDAL. Any sports team or sporting event can also sell tickets directly to the user such as by advertising or while the user is watching a game. For example, the tickets can be for football (NFL), basketball (NBA), baseball (MLB), hockey (NHL), soccer, horse racing, car racing (NASCAR), university sports (NCAA), local teams, Olympic events, or international events.

With services, if a company with a service has an ad, the user can pause the media and click on a link, click on the button that remains on the screen, scan the QR code, or text a number to make an appointment for that service, such as for beauty services, haircuts, auto repair services, home repair services, healthcare services, or legal services. Any intake forms can be obtained by the user, filled out, and submitted to the company providing the service with the store section. For example, for legal services in order to set up a meeting with an attorney, the user can set up an interview with an attorney, answer preliminary questions, and submit evidence.

For example, if the user is watching “The View,” and they like the reading glasses that a co-host is wearing, a link can be generated for those glasses that the user can click on and buy the glasses. The user can pause the media that they are viewing (whether by operating a remote control, mouse, or touchscreen), and options of items for purchase can be presented on the screen either automatically (and include an indication that the item is for sale, such as a graphic display or icon with the name of the item and its price and/or source) or when the user clicks on or moves a mouse over a certain item. This allows the user to browse and select items without any disruption to the media, and the user can conveniently navigate through thee displayed items and select an item they wish to purchase. Every item can be displayed for sale in the scene to the user or a single item that the user selects from the display. Users can also gift products to other users in the system or other individuals outside of the system. For example, users can gift a streaming package or digital gift cards to other users. Gift cards can be added to the other user's user profile for purchasing media content or other products that they desire. Users can also gift products (such as those advertised based on the other user's profile, or listed on a “Gift Me” section of the user's profile that is viewable to other users in which the user has liked or selected a particular item that they are interested in having purchased for them) and have them shipped to another user. Users can also view any products for sale in a 360 degree view (or 3D) such that the user can select or click on the product and move the product around in 360 degrees, allowing the user to see the product from all sides.

Users can also list their own products for sale in the store section to other users, as well as advertise their products to other users and upload their own advertisements or commercials.

Users can store their payment (credit card/debit card/banking) information in their profile, along with their address on non-transitory computer-readable media to make transactions within the user system 14 easy, quick, and secure and without the need for repetitive data entry during each transaction. Users can also have existing payment information linked or synced to their account that stores a credit card or debit card, such as with Apple Pay, PAYPAL®, Google Wallet, Google Pay, or a remote wallet associated with a website (such as Fan Duel, etc.) If the user does not complete a transaction on an outside website, users can add items to a shopping cart within the user system 14 and check out with their payment information to have their items delivered. In general, when the user pauses the media, moves a curser on a remote control, or touches a screen on the user system 14, accesses the store section through a text or QR code on a mobile device, or places their smart device within range of a media screen with NFC technology capabilities (i.e. initiating a connection between the smart/mobile device and media screen with NFC technology such as by tapping or pairing a smart/mobile device to a media screen), options can pop up on the user interface 32 for recording, sharing, purchasing, betting, or gifting (i.e. icons can pop up with choices of actions). For screens that are not touch or curser activated, the icons can remain on the screen at all times. This allows the user to easily select an option and proceed with what they want to do. The user can click on the item they want to purchase and it can be added to a shopping cart, the payment information can be attached to the user's account and they can purchase the item seamlessly without exiting the viewing platform and then the transaction can be closed. With touchscreens, a user can circle or tap a desired item or betting odd to select the item. This essentially provides a one-click function for shopping. A one-click function icon can appear on the screen of the user interface 32 after an item or items are selected for purchase, which the user can toggle to seamlessly proceed with the purchase of the item.

The system can also include push notifications that allow parental control approval to protect against unapproved purchases. The push notifications can be sent to an account holder of a payment method when a transaction is attempted. Children or other individuals can have a user profile that a payment method is attached to. The account holder for the payment method can be required to approve purchases made using their method of purchase, such as confirming or denying the purchase.

Companies can locate customers (users) for merchandise sales based on their interests. Artificial intelligence on the user system 14 can collect data based on user activity on the user system 14 and this can be used to target users to send advertisements and promotions for one click check out. For example, the NFL may want to sell more Mahomes jerseys. The system of the present invention can locate users with this interest and advertise to them. Companies can also load certain merchandise that are available during a broadcast of media onto the system. For example, during an NFL game of Bears versus Lions, the NFL can make the jerseys of players playing in that game available so upon pressing pause or tapping a touchscreen a user can select the jersey they desire and check out seamlessly with one click purchasing. Companies can also partner with the system and application to promote their merchandise/products instead of merchandise/products of a competitor. For example, a user is watching a DIY show and they want to buy a door. Home Depot can partner with the system so that the user is automatically directed to doors that Home Depot is selling instead of doors that Lowe's is selling.

Therefore, the present invention also provides for a method of shopping and promoting products on media, by a user playing media and accessing a store section on a user system 14 having a user interface 32, software recognizing and assigning functional tags to purchasable items in the media, the functional tags not being visually displayed on a screen during media playback, the items being promoted by a company that is partnered with the user system 14 instead of a competitor, the user selecting an item in the media for purchase, the user accessing a one-click purchase function in the user interface 32, and the user purchasing the item seamlessly. This method can also include any of the other steps or details described herein. This method can also be used with the betting module to allow a user to place bets (i.e., the item for purchase can be a bet).

The system can further allow for geo tag purchases that allow exclusive rights to unlock sales for merchandise based on a user's location. For example, an artist can move merchandise to attendees without them having to stand in line to purchase. Simply because the attendees are in the venue they can make purchases based off their geographical location.

In one example with the store section, a user is watching TV and sees a tie that George Clooney is wearing, the user can pause the screen, the option to record, share, or purchase pops up on the screen, the user can select purchase for any item that is tagged for purchase such as the tie, the item goes into their shopping cart, and having payment information attached to the user account allows the user to purchase or gift the tie that they want without exiting the viewing platform. In another example, a child is watching a DISNEY® movie and their parent hears them ask for a Princess Jasmine costume seen in the movie. The parent can pause the screen, select the costume, and purchase it without changing the channel or having to search on another market/platform.

Presently, when a person enters a common space such as a bar, restaurant, or friend's home to watch media broadcast or streamed, they need to connect to a website or go through a QR code in order to make a purchase or bet. This takes time, can be multi-step, and awkward. The present invention provides a simpler way to purchase and/or bet from common spaces.

With the present invention, when a user enters an establishment such as a bar showing sporting events or is watching media on a television (at their home or another person's home), the media playing/broadcaster/streaming service can provide/display a code to text or a QR code for scanning that is unique to that media program/channel allowing the user to access the user interface 32 from their mobile device (smartphone, tablet, etc.) such as through a website or application. The mobile device is remote from the media being shown (i.e., the media is being shown on a television/screen that is not part of the user interface 32 or mobile device). The mobile device can also use the establishment's Wi-Fi or BLUETOOTH® in connecting with media or the establishment's website or use NFC technology when placed within range of a media screen. The text code can be sent through a user's mobile device or scanning a QR code with a camera on the user's mobile device can generate a link to a website associated with the user interface 32. A QR code is essentially a barcode that can be read to convert it to a URL for a website or launch an application. This can be beneficial when many people are watching the same media and the user does not have access to the television or device that is streaming the media and/or does not want to disturb other people in order to purchase items or make bets. All of the items in the media are listed in the shopping section of the user interface 32 in real time as shown in the media and the user can select an item or service for purchase, order food, or place a bet. Items can be listed in drop down menus for selecting the source of goods or services, such as jerseys, tacos, etc. This technology avoids the awkwardness of trying to match and/or pair a smartphone camera to a screen showing a QR code. The present invention allows any item presented on broadcast or streamed content to be available to users for purchase within seconds. Ordering can go through a distributor (such as Amazon), directly from the source (such as Taco Bell), or directly from a casino (such as FanDuel or MGM).

For example, an NFL game has a code showing on the lower corner of the television screen “7245”. The user can text the number, and they are sent to the user interface 32 where all items available for purchase on the current screen can easily be selected for a one-click check out. If the Lions and Bears are playing, the NFL can include all merchandise associated with those two teams readily available for purchase through the code provided on the screen displaying the game. No search is required for the user. In a bar with multiple televisions each playing different games or media, each game can show its own text code/QR code.

Furthermore, each unique establishment is able to purchase rights to make the number to text or QR code unique to their establishment, i.e., the establishment can be provided with their own unique text code or QR code. This allows the establishment the opportunity to integrate with the user interface 32 in order to offer their own items unique to their location or unique to their business and provides seamless access to the customer without interruption. This also provides an additional space for the establishment to advertise for themselves and offer special deals that can be easily adjusted to unique events, as well as provide an ordering system for the user. Any business using the QR code or text number can have a geofence set up that once a user walks into the geofence area, a notification is pushed to the user system 14 through an application letting the user know that purchasing/betting is available and Wi-Fi details, text codes, or QR codes can be displayed (or directed to take a picture of at a certain location in the business) for the user to connect with.

For example, an NFL game is showing the code 7245 on the lower corner of the television. However, the location the customer is watching in has the further distinction of 89001. The user then texts the expanded number and they are sent to a version of user interface 32 where items unique to this location are available for ordering and purchase. No search is required for the user. In a bar with multiple televisions each playing different games or media, while each game can show its own text code/QR code, the store specific portion of the code is the same.

Using the text code to access the user interface 32 also allows the user to access any other functions described herein (such as messaging, sharing purchases, gifting, etc.) If the user is at a live event and also accessing a broadcast with a delay, any purchase/bet can also be required to proceed with a delay so that a user is not betting on something that has not yet been shown on the broadcast.

The present invention therefore provides for a shopping interface for purchasing items on media, including the user system 14 having a user interface 32 displaying items for purchase that is accessible through a user initiating a connection between a mobile device of a user system having a user interface and a media screen that pushes data of items for purchase or available bets to the mobile device, wherein the user interface 32 is remote from the media being shown, the user system 14 including software stored on non-transitory computer readable media that recognizes and tags purchasable items in the media, wherein the user system 14 displays items for purchase, the user system 14 including a one-click purchase function allowing for secure and efficient purchases. The one-click purchase function can securely store payment and address information of the user on non-transitory computer readable media or can link with and use existing payment information as described above. The items displayed for purchase can also include food and the details of the food ordering module described below can be included in this system, and the items for purchase can also be bets as further described below.

The present invention also provides for a method of shopping on media, including the steps of a user initiating a connection between a mobile device of a user system 14 having a user interface 32 and a media screen that pushes data of items for purchase or available bets to the mobile device, wherein the user interface 32 is remote from the media being shown, software recognizing and assigning functional tags to purchasable items in the media, the functional tags not being visually displayed on a screen during media playback, the user selecting an item in the media by clicking on it, the user accessing a one-click purchase function on the screen, and the user purchasing the item seamlessly such as with using stored payment and address information securely stored on non-transitory computer-readable media within the user system 14 or linking and using existing payment information of the user. The items displayed for purchase can also include food and the details of the food ordering module described below can be included in this system, and the items can also include bets as further described below.

The user interface 32 can further include a search mechanism that allows individual users to search for media or particular scenes in media as well as products. Media can be searched by users by keywords (such as any identifying information in a particular scene or moment, landmarks, actor name, director name, type of media such as commercial, sports event, movie, or tv program, genre of media (drama, comedy, news, documentary, etc.), or combinations thereof located in the file name, file description, or meta data. If a media file itself has identifying information within scenes, that can be searched. Clips or portions of media can be saved by users (such as individuals, actors, or directors) in their account and can be searchable. For example, a user can search for “Scene in Forest Gump, when Forest runs through water at the National Mall in DC.” Any clips/portions returned by the search results can then be selected and shared with other users or edited further (to select a particular scene or moment) and then shared. Actors can also narrate scenes and explain to viewers what was going on in their mind during that scene and provide the scenes as clips for users to share. Media can be searched to find items for users to make purchases (such as clothing, shoes, jewelry, electronics, or home items) that appear in media. For example, a user can search for Ann Hathaway because they like the dress she had on in the movie “The Intern” at a certain scene. The search results can provide a link to purchase or a link to purchase within the store section as above. The search mechanism allows users to find content without having to leave the platform of the user system 14.

The user interface 32 can include a video recording mechanism, wherein users can record a video of themselves and share the video with other users through the user system 14. For example, users can record themselves reenacting scenes from movies, shows, commercials, video games, etc. The video recording mechanism can use sounds from any media (background music or other sounds) to bring reenactments to life. Users can also speak along with their favorite scenes or actors for performing complete in sync voice overs. Users can also create challenges with other users to create reenactments, which promotes social use of the media sharing and communication system 10. Users can also just create a video of themselves and speak about the media that they have viewed and/or shared with other users.

The user interface 32 can include a live interaction mechanism that allows a user to interact with a live media program and connect with an individual or individuals on the media, such as athletes, actors, analysts, or other media personalities. An icon on the user interface 32 can allow a user to make an interaction such as calling on a phone, sending a text, or making a video call (such as with FACETIME®, SKYPE®, WHATSAPP®) to the media program and interact with the individuals on the media program.

The user interface 32 can include an online betting module that allows users to bet on sports events (such as NBA, NFL, NHL, MLB, NASCAR), online games that users play against each other, or any other event taking place (elections, stocks, news, etc.). The online betting module can include an age verification mechanism according to requirements of cities, states, and/or countries. Bets can be placed before or during an event. The online betting module can be easily accessible through a button or icon on the user interface 32, or through the text code or QR code, or NFC technology described above, as well as voice commands. Any betting statistics related to the media can be shown on the user interface 32 either superimposed on the media or a separate bar at the side, bottom, or top of the media.

With the online betting module, when a user is making a bet in real-time, an algorithm in the user system 14 freezes action within the event to the user so that the action and odds do not move or change to protect the user from betting as odds go down and protecting a host betting company from the user seeing results of the bet (sinking putt, handoff instead of pass, etc.) before placing the bet. In other words, it is critical to ensure fairness for both users and a betting company while maintaining the integrity of the betting process. This can apply to any action of the user wherein the action is based on an event about to happen or any changing target. The target could be odds or stock price (such as watching MSNBC or FOX Business and buying and selling stock). The user needs to act in a frozen time frame.

In order to accomplish this, an algorithm constantly monitors the changing odds or target variables (such as value token) in real-time. When a user decides to place a bet, the algorithm temporarily freezes the action for that user. This means that the odds or target variables are locked in at the moment the user initiates the bet, preventing them from changing during the betting process. Freezing the action protects users from experiencing unfavorable changes in odds before they place their bets. It ensures that users receive fair and consistent terms at the time of betting, regardless of any fluctuations that may occur afterward. On the other hand, freezing the action also safeguards the betting company from users exploiting last-minute changes in odds to their advantage. By locking in the odds at the time of betting, the company can manage its risk exposure more effectively and maintain the integrity of its operations. The algorithm continues to monitor the ongoing events or market conditions even after the bet is placed. If any significant changes occur before the event concludes (such as a drastic shift in odds), appropriate measures can be taken to ensure fairness and integrity, such as offering refunds or adjusting payouts.

The user can use voice commands to place a bet with the online betting module in real-time. The voice command can initiate the algorithm to freeze the action while making the bet. For example, betting by voice command before a putt does not last so long that the putt is made or missed during the voice command bet. Therefore, the algorithm is designed to operate in real-time, syncing with a streaming service/media provider to provide users with a seamless experience of watching and betting simultaneously. This means that the algorithm processes voice commands quickly and efficiently, without causing delays that could impact the user's ability to place timely bets. The algorithm incorporates control mechanisms to manage the timing of bets. For example, it freezes action only during the brief moment when the user is placing a bet via voice command, ensuring that the user's betting experience aligns with the live action on the screen. Security features are integrated into the algorithm to guarantee the accuracy and validity of bets. This can include verification steps to ensure that bets are properly executed and recorded, as well as encryption protocols to safeguard user information and financial transactions. To prevent actions from overtaking bets, the algorithm executes voice-command bets with near-instantaneous speed. This ensures that bets are placed in a timely manner, even during fast-paced events like sports games. The algorithm continuously monitors the betting process to detect any anomalies or discrepancies, providing assurance to both users and the betting platform that bets are processed accurately and securely.

Therefore, the present invention also provides for a system for betting on media, including a user system having a user interface displaying media, the user system including the betting module having an algorithm stored on non-transitory computer readable media that allows a user to place a bet on an event in the media in real-time, the algorithm freezing action in the media temporarily for the user while the bet is placed, and the user system including a one-click purchase function for securely storing payment and address information of the user on non-transitory computer readable media allowing for secure and efficient placing of bets.

The present invention also provides for a method of betting on media, by a user placing a bet on an event in the media in real-time by activating an algorithm stored on non-transitory computer readable media on a user system, freezing action in the media temporarily for the user while the bet is placed with the algorithm, and the user placing the bet seamlessly using stored payment and address information securely stored on non-transitory computer-readable media within the user system. The method can include any of the steps described above.

The user interface 32 can further include an online food ordering module that allows users to order food advertised in commercials or online ads (such as a pizza store, a fast food company, a convenience store), as well as the type of food shown in a media program such as a tv show or movie. For example, a tv show may feature the cast eating at a high end restaurant, and different high end restaurants can be displayed on the user interface as offering online ordering and optionally delivery to the user. A cooking show can feature a particular type of cuisine (such as Chinese, Mexican, Japanese, Indian, Italian, Vietnamese, French, Fusion, Southern, Middle Eastern, Korean, Spanish, Eastern European, etc.), and the user interface can display restaurants of that type of cuisine that offer online ordering and delivery. A user can click on the restaurant and order food for either pick up or delivery. The user interface 32 can interact with existing food ordering/delivery platforms such as Seamless, Grubhub, Uber Eats, Postmates, Yelp, Caviar, DoorDash, and others. The online food ordering module can also be easily accessible through a button or icon on the user interface 32 or by a text code or QR code or NFC technology as described above. A user can also gift food and delivery to another user, and addresses of other users (contacts) can be stored in the user system 14 to easily send these items to another user. As with the store section, the online food ordering module can use a software program to identify and tag food items for purchase. Any food item within the media can be recognized with the software program and identified as an item available for purchase and that item can be located at a restaurant or delivery platform for purchase. The software program can analyze images within the media for pixel values and gradients to compare to images of food items available for sale in order to correctly identify the food items.

The user system 14 can also be in electronic communication with a camera (such as on a smartphone) so that a user can take a picture or view a separate screen or a store window with the camera and the user system 14 can identify items on the screen/in the store window/in the picture to purchase or place a bet on a sporting event. For example, a user can be watching a game at a bar, and they see an item they want to purchase, food they want to purchase, or decide they want to place a bet. They can open the camera on their smartphone and options for purchase syncs with the user system 14 and the user is prompted to continue with the purchase or bet. In another example, a user can pass by a store window, they aim the camera at the window or take a picture of the window, the user system 14 icons pop up, the items are identified as well as their source (from a store such as Saks Fifth Avenue, J. Crew, The Gap, etc.), and the user can make a purchase.

In one exemplary embodiment the user system 14 includes suitable software and user interface 32 for generating a user profile and attract other users or followers from social networks such as FACEBOOK®, TWITTER®, or otherwise, based upon the type of programming the user views. The user profile includes information of an individual user of the user system 14 to provide an indication of personal preference. For example, information that can be inputted into the user interface includes types of media, e.g., audio, video or identification information that a user enjoys. Other user preferences includes programming likes and dislikes including sports, movies, programming, celebrities, commercials, games, or otherwise. Other user preferences are possible. Users can also like or love any media, and this can be visible on their user profile and/or visible to other users or friends.

In greater detail, in one exemplary embodiment, the user profile provides the ability to indicate or like special interests or subscribe to their favorite athletes, actors, brands, or teams. In one particular configuration, the user profile is used to generate suggested viewing. The user profile provides the ability of a user to indicate particular interests which may include a particular actor, athlete, team, programming type (including shows and channels) or otherwise. Based upon the user profile, the media sharing and communication system 10 generates a listing of program based upon the user programming, which may include similar interest such as indicated actors, athletes, programming type or otherwise. Traditional methods require the user to search for something and then they begin to see advertisements directed towards their search. The present invention reverses this process. Artificial intelligence (AI) and tagging can be used to notify a user that a favorite person, brand, or team is going to be on a show/sports match/interview/other media program. Notifications can be provided in advance and/or at the time of the media broadcast. AI can use the likes or subscriptions to track viewers and tailor their viewing experience while using the system.

For example, should the user profile indicate a favorite baseball player and the particular baseball player is participating in an interview on one programming channel, such as a finance channel, the system 10 would indicate to the user that a player indicated in their user profile is on a particular channel providing the ability of the user to watch or record the particular programming. This concept can also be applied to actors, movie types, sports, other players, automobile manufactures or otherwise.

The user profile as visible in user interface 32 can further include tabs for trending news, sports, products, or clips of media. The user can add particular news sources, sports teams, or products they are interested in, and/or these can be generated based on information in the user profile. Users can also receive news updates based on their interests and preferences (such as finance, sports, local, etc.).

User profiles can also be tailored to a particular age group, such as for kids, with tailored advertising and suggested media suitable for a particular age group.

The communication system 10 provides socialization between users. The individual user of the user system 14 can send and receive a friend request, which must be approved by the recipient (i.e., second user system 14), in order to be added to the friend list and receive media. The communication system 10 is further configured to suggest friends or other users that have similar interest so that media can be sent to individuals, of a user profile friend list, that has similar interests. The communication system 10 further provides the ability to set up a notification that will notify a user when other users are online or offline. The individual user can also have an open profile option that allows anyone to follow them or send media, promoting community and meeting new people. A user can search for friends by name, username, gamer tag, telephone, address, or email that have been used in setting up a user profile.

In one particular exemplary embodiment, the user system 14 is integrated in hardware and/or software components of a cellular phone, i.e., smartphone, or tablet and is accessible to the user in the form of an application stored on non-transitory computer readable media or stored in a cloud. For example, the transmitter/receiver 22 comprises a transmitter/receiver 22 used in cellular phones for cellular communication. The display screen 24 comprises a screen and user interface of the cellular phone. Further, the cellular phone includes a digital recording device comprising a memory module for recording media, generating user interfaces, generating messages, combinations thereof or otherwise.

In one particular mode of operation, referring again to FIGS. 1-5, during viewing of media being disseminated from the media content provider 12, should the viewer find a particular media content of interest, the user records and initiates the user interface 32 to select other users to which to share the media content with. Optionally, the user includes a message with the recorded media, such as “check this out”, “did you see that play”, “best part of the movie”, or otherwise. The recorded media and message is sent to another user system 14, through the media content provider 12 and more specifically receiver 20. Should the recipient be authorized to receive the media and have sufficient memory, the message and media is transferred to the second user system 14. A user can also send a message to a second user about recommended programming that the second user may like.

Any commands within the user system 14 can be actuated (received and executed) through the voice of the individual users. For example, the individual user can use a voice command to rewind media, fast forward media, record media, add a message to the recorded media, and send the media and/or message to another user, as well as make purchases in the store section, use the online food ordering module (ordering or searching for food), use the betting module (placing and confirming bets), and gift items. Any of the commands can be actuated for a set amount of time determined by the user (such as by seconds (5 seconds, 10 seconds, 25 seconds) or minutes (1 minute, 5 minutes, 10 minutes)) at the time the voice command is given. For example, the individual user can command “Rewind by 10 seconds and record for 25 seconds. Send to Joe.” The individual user can command “purchase the red hat and send it to Sheryl.”

In particular, when the message is a voice commentary, this allows the users (whether sending or receiving) to narrate clips or portions of media and to have open dialogue about particular clips of interest. This can allow the user the opportunity to act as a news anchor or sports commentator. Voice commentary allows the user to express with great detail what that media portion means to them along with why they decided to send it to a particular user. This can enhance the television viewing experience with friends and family when users are in two different households, and gives the user an opportunity to explain to the other user why they feel they should or should not like a show, actor, sports team, etc. With the voice commentary, the user can also talk over a desired portion of media, much like a sports commentator or news anchor, and narrate the portion of media.

The present invention creates excitement for the user when a user turns on their user system 14 and is notified that they have messages in their INBOX from friends and family as in FIG. 5. The present invention helps reduce channel surfing, because when a user turns on their user system 14, they have suggested media to review from their INBOX, as well as suggestions for media to view based on their likes and interests from their user profile, such as an actress they like is on a talk show at a certain time, a particular category of media (action, architecture, sports, animals, drama), or their favorite sports team is playing on a particular channel. Also, the user system 14 can allow for individual users to see what their friends are watching, and they can be notified either in their INBOX or on their display screen 24. This can promote group watching where the individual user can start watching a program along with their friend or group of friends.

Users can further send messages to other users without a media file attached with it. For example, a user can send another user a reminder that a program they like was on earlier, or simply send messages not related to media files such as greetings to another user. Users can also message each other while watching a live program, and this provides users the ability to watch a program together while being in different locations. Messages can pop up on their display screen 24 of their user system 14 or go directly to their INBOX while watching a live program.

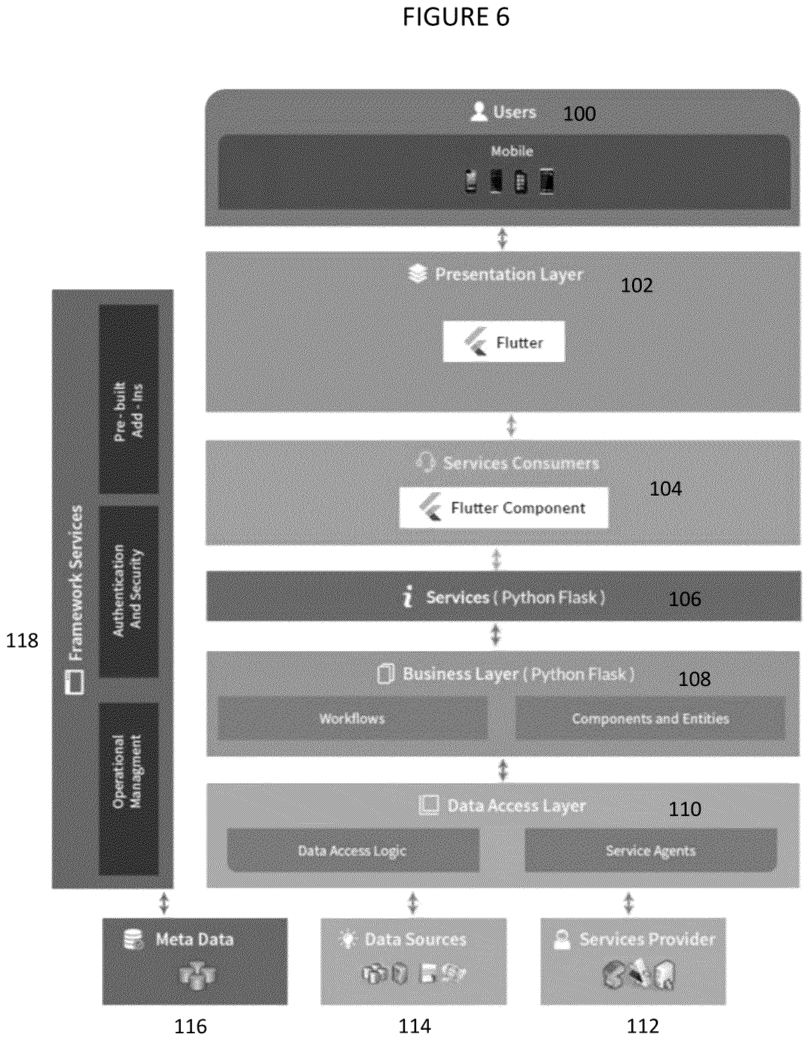

The user system 14 includes architecture as generally shown in FIG. 6. Users at 100 use their smartphone, tablet, other mobile devices, etc. including the user system 14 integrated therein (such as with the application) and access a presentation layer 102. The presentation layer 102 is responsible for data handling and graphic management which ensures that the communications that pass through it are in the appropriate form for the recipient application. Flutter is one example of a scripting language that can be used, it is an open-source user interface software development kit created by Google. The presentation layer 102 is in electronic communication with services consumers 104. The services consumers 104 is in electronic communication with services (Python flask) 106. The services (Python flask) 106 is in electronic communication with a business layer 108, which includes workflows and components and entities. In the business layer 108, Node can be used for a backend and for REST API's which works as a handshaking mechanism between the business layer 108 and the presentation layer 102. The business layer 108 is in electronic communication with a data access layer 110, which includes data access logic and service agents. The data access layer 110 is in electronic communication with services provider 112 and data sources 114. Meta data 116 is in electronic communication with framework services 118. The framework services 118 can include operational management, authentication and security, and pre-built add-ins.

The present invention also provides for a method of sharing portions of media and watching a live program, by a first individual user recording a portion of media and recording a message (such as video, text, voice, or combinations thereof), transmitting the portion of media and message to a second individual user if the second individual user is authorized to view the portion of media, the second individual user viewing the portion of media and message, the first individual user recording a message during a live program and transmitting the message to the second individual user, and the second individual user recording a message during the live program and transmitting the message to the first individual user. This method can be performed by using the media sharing and communications system 10 described above. More particularly, the recording step is further defined as the first individual user recording a portion of media with a recording mechanism 26 in a first user system 14, the transmitting step is further defined as transmitting the portion of media and message with a first user transmitter/receiver 22 to a second user transmitter/receiver 22, and the viewing step is further defined as a second individual user viewing the portion of media and message with a second user system 14. Any notifications described above can be sent to the first individual user or second individual user, such as notifying the first individual user if the second individual user is not authorized to view the portion of media. The users can create user profiles and the user systems 14 can generate suggested programming based on the user profile. The method can further include notifying the first (or second) individual user of messages in an inbox and suggestions of programming when the first (or second) user system 14 is turned on. The users can also shop in the store section of the user system 14 or list products for sale. The users can place an online bet with the online betting module. The users can order food with the online food ordering module. The first individual user can also record a video of themselves and share the video with the second individual user as described above. While watching the live programming, any users can also live stream a video of themselves to share with other users in the group watching the media on their user interfaces 32. The streaming videos can appear to the side of the media being watched or be minimized when desired.

The present invention also provides for method of sharing media by a first individual user searching for media of program information, programming shows, movies, concerts, sporting events, online games, or commercials by keywords and selecting a portion of media returned in search results, the first individual user recording a message of video, text, voice, emojis, images, or combinations thereof, transmitting the portion of media and message to a second individual user if the second individual user is authorized to view the portion of media, and the second individual user viewing the portion of media and message. The searching step is performed with the searching mechanism as described above. The first individual user can also record a video of themselves and share the video with the second individual user as described above.

The present invention also generally provides for a method of sharing portions of media, by a first individual user recording a portion of media and recording a message chosen from the group consisting of video, text, voice, and combinations thereof, transmitting the portion of media and message to a second individual user if the second individual user is authorized to view the portion of media, the second individual user viewing the portion of media and message, the first individual user recording a message and transmitting the message to the second individual user, and the second individual user recording a message and transmitting the message to the first individual user, wherein any of the steps are performed by a voice command. The first individual user can also record a video of themselves and share the video with the second individual user as described above.

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teaching provided herein.

### Example 1

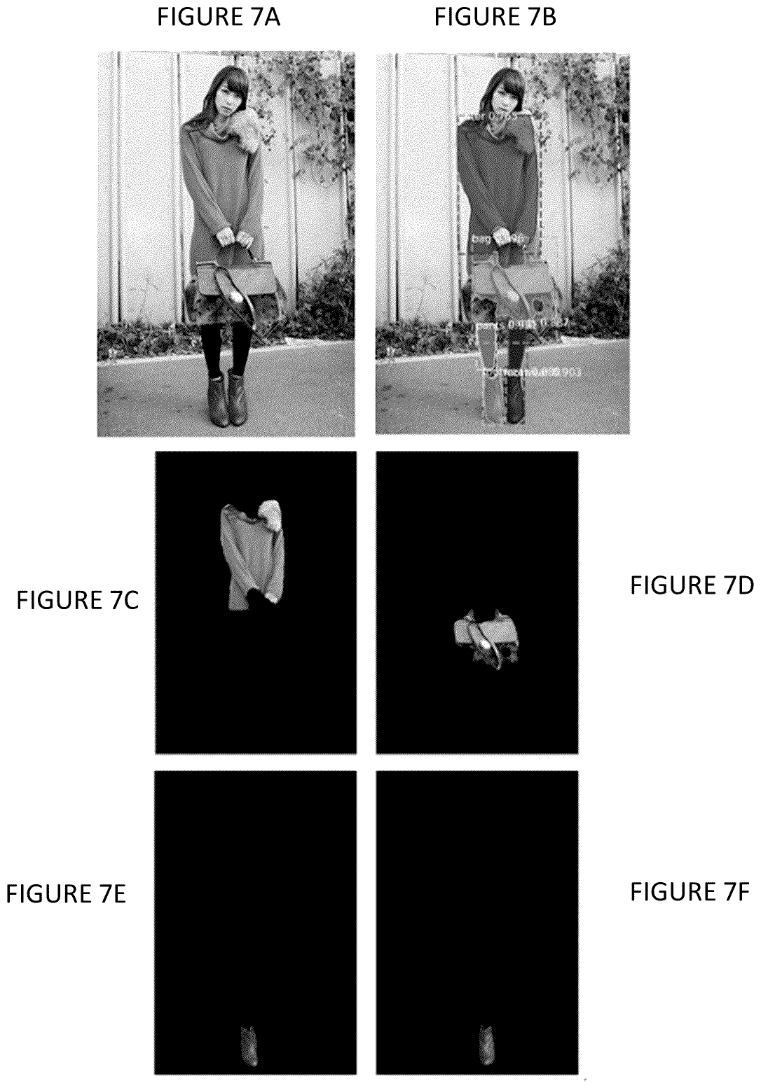

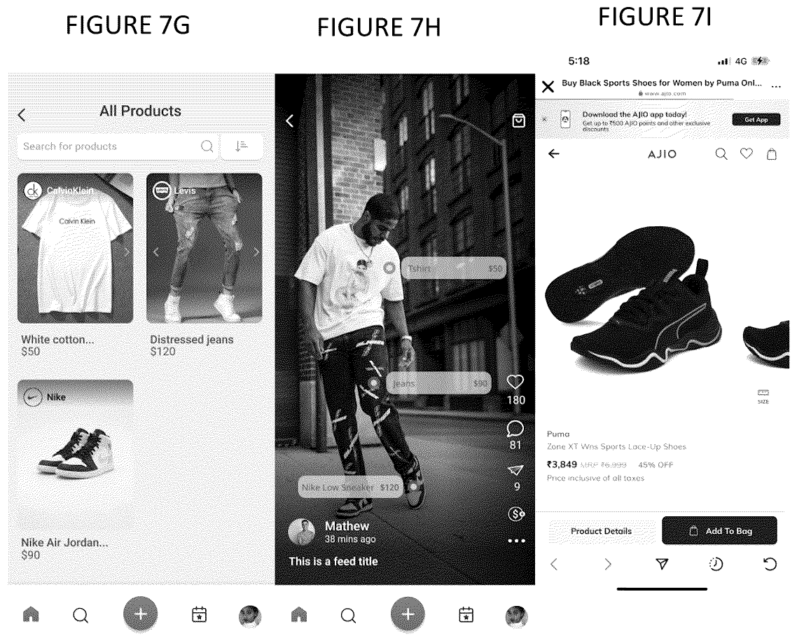

The following method was used to extract merchandise, clothing, etc. for product recognition from media content so that it can be searched in the open marketplace on any website. In one particular example, the product can be found in the Amazon marketplace to provide quick checkout and tracking. Example segmentation is shown in FIGS. 7A-7I.

FIG. 7A shows an outfit found in media, FIG. 7B shows recognition of pieces of an outfit, FIG. 7C shows a coat, FIG. 7D shows a bag, FIG. 7E shows a shoe, and FIG. 7F shows a shoe. FIG. 7G shows products found and recognized in the media image of FIG. 7H, and FIG. 7I shows suggested products based on the image of FIG. 7H.

For example, the user system 14 allows the user to download the media (from any source such as, but not limited to, YOUTUBE®), frames of a time period of one second can be extracted using cv2library (such that a 10 second video extracts 10 frames), and the extracted frames are passed to a Mask ROCNNN model to identify products/clothes in the frames and it identifies and marks the portion of the detected items. The detected items are cropped using cv2 crop tool and based on the dimensions the data is saved on the server. The cropped items are taken and sent to a web automation tool (such as selenium webdriver), which automatically uses the cropped images and searches with Amazon StyleSnap to find related results and/or searches with Google and selects the images that have the same product tag to redirect the user to the relatable source. If Chrome-driver is used as a browser and the match is found, it can be uploaded onto an S3 server and at the same time a database is updated. The user system 14 then deletes the folder created on the server because all the data is in the database itself.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A shopping interface for purchasing items on media, comprising:
a user system including a user interface displaying items for purchase that is accessible through a user initiating a connection between a mobile device and a media screen that pushes data of items for purchase or available bets to said mobile device, wherein said user interface is remote from the media being shown on said media screen,
said user system including software stored on non-transitory computer readable media that recognizes and tags purchasable items in said media, wherein said user system displays items for purchase, and
said user system including a one-click purchase function allowing for secure and efficient purchases.

2. The shopping interface of claim 1, wherein said connection is a near field communication (NFC) connection.

3. The shopping interface of claim 1, wherein said items for purchase are gifted to an individual.

4. The shopping interface of claim 1, wherein said software is further defined as software that recognizes and tags items available to purchase in said media by analyzing images within said media for pixel values and gradients to compare to images of items available for sale in order to correctly identify the items.

5. The shopping interface of claim 1, wherein said user system further includes:
a recording mechanism that records a desired portion of media upon activation by a first individual user who is not a content provider, the portion of media being less than a full media episode;
a friend request mechanism for sending and receiving friend requests between users to be approved to receive and share media and wherein the friend request mechanism suggests friends who have similar interests of the first individual user, and wherein the friends are searchable by information chosen from the group consisting of name, user name, gamer tag, telephone, address, and email;
a first user transmitter/receiver included in the user system that transmits the portion of media and a message generated by the first individual user regarding the portion of media to a second individual user who is not a content provider, the user system including the user interface having an input device and screen view that is generated by software stored on a memory device of the first user transmitter/receiver, the user system including a user profile generator interface and a store section for shopping for products and listing products for sale;
a confirmation mechanism that confirms that the second individual user is authorized to view the portion of media and a notification mechanism that notifies the first individual user if the second individual user is not authorized to receive the portion of media and notifies the second individual user that the portion of media cannot be received due to programming configuration subscribed to by the second individual user; and
a second user transmitter/receiver included in a second user system that receives the portion of media upon authorization of the second individual user; the second user system including a second user interface having an input device and screen view that is generated by software stored on a memory device of the second user transmitter/receiver, the second user system including a user profile generator interface and a store section for shopping for products and listing products for sale, wherein said store section includes software that recognizes and tags items available to purchase in said media.

6. The shopping interface of claim 5, wherein said user system further includes a search mechanism that allows the first individual user and second individual user to search by keywords for media and products used in media.

7. The shopping interface of claim 5, wherein said user system further includes a video recording mechanism that allows the first individual user to record a video of themselves and share the video with the second individual user.

8. The shopping interface of claim 1, wherein said user system further includes an online betting module accessible by initiating a connection between the mobile device and a media screen that allows the first individual user to place bets on events, and wherein a bet can be placed before or during the events, and including an age verification mechanism.

9. The shopping interface of claim 8, wherein said betting module includes an algorithm stored on non-transitory computer readable media that allows the user to place a bet on an event in real-time, the algorithm freezing action in the media temporarily for the user while the bet is placed.

10. The shopping interface of claim 1, wherein said user system further includes an online food ordering module accessible by initiating a connection between the mobile device and a media screen that allows the first individual user to order food from food advertised in a commercial, food advertised in an online ad, and food shown in a media program, wherein the online food ordering module interacts with an existing food ordering and delivery platform, wherein the first individual user can gift food and delivery to another user, and wherein said online food ordering module includes software that recognizes and tags food available to order in said media by analyzing images within said media for pixel values and gradients to compare to images of food items available for sale in order to correctly identify the food items.

11. The shopping interface of claim 5, wherein said user interface further includes a quick share button that allows for instant recording of media for a length of time chosen from the group consisting of 5 seconds, 10 seconds, 15 seconds, 30 seconds, 1 minute, and 5 minutes.

12. The shopping interface of claim 5, wherein the user system and second user system are capable of receiving and executing voice commands chosen from the group consisting of rewinding media, fast forwarding media, recording media, adding a message to recorded media, and sending media and/or a message.

13. The shopping interface of claim 5, wherein said user system and said second user system are integrated in a smartphone or tablet and are accessible by using an application stored on non-transitory computer readable media.

14. The shopping interface of claim 5, wherein said media is chosen from the group consisting of program information, programming shows, movies, concerts, sporting events, online games, preset blocks of media, and commercials.

15. The shopping interface of claim 5, wherein the second user transmitter/receiver includes a recording mechanism that records a desired portion of media upon activation by the second individual user and can transmit the portion of media to the first individual user.

16. The shopping interface of claim 5, wherein the user interface transmits the portion of media to the second user transmitter/receiver based upon a profile established through a user interface of the second user transmitter/receiver.

17. The shopping interface of claim 5, wherein the profile comprises select program or program type disseminated by a media content provider and personal information of the user of the first user transmitter/receiver.

18. The shopping interface of claim 5, wherein the message is chosen from the group consisting of text, voice, video, emojis, and images.

19. The shopping interface of claim 5, wherein the products are chosen from the group consisting of product directly advertised to the first individual user, products based on a user profile, products shown in a program, and combinations thereof.

20. The shopping interface of claim 1, wherein said user interface allows said user to view said item in a 360 degree view.

21. The shopping interface of claim 1, wherein said user system includes push notifications for allowing approval to protect against unapproved purchases.

22. The shopping interface of claim 1, wherein said user system allows for geo tag purchases.

23. The shopping interface of claim 22, wherein said user system allows for notifications to be pushed to said user system when in a geofence area.

24. The shopping interface of claim 23, wherein said notifications are chosen from the group consisting of purchasing or betting is available, Wi-Fi details, text codes, QR codes, and combinations thereof.

25. The shopping interface of claim 1, further including artificial intelligence that collects data based on user activity for use in advertising.

26. The shopping interface of claim 1, wherein said one-click purchase function securely stores payment and address information of said user on non-transitory computer readable media.

27. The shopping interface of claim 1, wherein said one-click purchase function is linked to existing payment information of said user.

28. A method of shopping on media, including the steps of:
a user initiating a connection between a mobile device of a user system having a user interface with a media screen that pushes data of items for purchase or available bets to the mobile device, wherein the user interface is remote from the media being shown;
software recognizing and assigning functional tags to purchasable items in the media, the functional tags not being visually displayed on a screen during media playback;
the user selecting an item in the media for purchase;
the user accessing a one-click purchase function in the user interface; and
the user purchasing the item seamlessly.

29. The method of claim 28, wherein the connection is a near field communication (NFC) connection.

30. The method of claim 28, wherein said purchasing step is further defined as the user purchasing the item and gifting the item to an individual with stored user payment and address information on non-transitory computer readable media of the first user system.

31. The method of claim 28, wherein said software recognizing and tagging step is further defined as analyzing images within the media for pixel values and gradients to compare to images of items available for sale in order to correctly identify the items.

32. The method of claim 28, further including the steps of:
a first individual user recording a portion of media and recording a message chosen from the group consisting of video, text, voice, emojis, images, and combinations thereof with the user interface on the user system;
transmitting the portion of media and message to a second individual user if the second individual user is authorized to view the portion of media; and
the second individual user viewing the portion of media and message with a second user interface on a second user system.

33. The method of claim 28, further including the step of the first individual user placing a bet on an event with an online betting module on the first user interface accessible by initiating a connection between the mobile device and a media screen, wherein the online betting module allows a bet to be placed before or during the event, and includes an age verification mechanism.

34. The method of claim 33, further including the step of delaying a bet when the user is at a live event and viewing media that is on a delay.

35. The method of claim 33, further including the step of the user placing a bet on an event in the media in real-time by activating an algorithm stored on non-transitory computer readable media on a user system, and freezing action in the media temporarily for the user while the bet is placed with the algorithm.

36. The method of claim 28, further including the step of the user ordering food with an online food ordering module accessible by initiating a connection between the mobile device and a media screen, wherein the online food ordering module allows the first individual user to order food from food advertised in a commercial, food advertised in an online ad, and food shown in a media program, wherein the online food ordering module interacts with an existing food ordering and delivery platform, and wherein the first individual user can gift food and delivery to another user.

37. The method of claim 28, further including the step of providing a unique text code or QR code to an establishment, wherein the establishment is able to integrate with the user interface to offer their own items unique to their location, advertise for themselves, and provide an ordering system for the user.

38. The method of claim 32, further including the step of the first individual user recording a video of themselves and sharing the video with the second individual user.

39. The method of claim 32, wherein each of the steps are performed using an application on a smartphone or tablet stored on non-transitory computer media.

40. The method of claim 32, further including before said first individual user recording a portion of media step, the step of the first individual user searching for media chosen from the group consisting of program information, programming shows, movies, concerts, sporting events, online games, and commercials by keywords and selecting a portion of media returned in search results.

41. The method of claim 32, further including the step of the first individual user searching for a product in media and purchasing the product through the first user interface.

42. The method of claim 32, wherein said recording step is further defined as the first individual user recording a portion of media with a recording mechanism in the user system, wherein said transmitting step is further defined as transmitting the portion of media and message with a first user transmitter/receiver to a second user transmitter/receiver, and wherein said viewing step is further defined as a second individual user viewing the portion of media and message with the second user system.

43. The method of claim 32, further including the step of notifying the first individual user if the second individual user is not authorized to view the portion of media.

44. The method of claim 32, further including the step of the first individual user creating a user profile, and the user system generating suggested programming based on the user profile.

45. The method of claim 32, further including the step of notifying the first individual user of messages in an inbox and suggestions of programming when the user system is turned on and notifying the first individual user that a friend is watching a program.

46. The method of claim 28, further including the step of the first individual user shopping for products from the first user interface chosen from the group consisting of product directly advertised to the first individual user, products based on a user profile, and combinations thereof.

47. The method of claim 32, further including the step of the first individual user listing products for sale on the user interface.

48. The method of claim 32, wherein the step of a first individual user recording a portion of media is performed with a quick share button that allows for instant recording of media for a length of time chosen from the group consisting of 5 seconds, 10 seconds, 15 seconds, 30 seconds, 1 minute, and 5 minutes.

49. The method of claim 32, wherein said user selecting an item in the media step further includes the step of the user viewing the item in 360 degrees.

50. The method of claim 28, further including the step of sending push notifications to an account holder of a payment method for allowing approval to protect against unapproved purchases.

51. The method of claim 28, further including the step of providing geo tag purchases and unlocking sales based on the user's location.

52. The method of claim 28, further including the step of pushing a notification to the user when the user is located in a geofenced area of a business.

53. The method of claim 52, wherein the notifications are chosen from the group consisting of purchasing or betting is available, Wi-Fi details, text codes, QR codes, and combinations thereof.

54. The method of claim 28, further including the step of artificial intelligence on the user system collecting data based on user activity for use in advertising.

55. The method of claim 28, further including the step of promoting a product by a company that has partnered with the user system instead of a competitor product.

56. The method of claim 28, wherein said purchasing step is further defined as a step chosen from the group consisting of using stored payment and address information securely stored on non-transitory computer-readable media within the user system and linking and using existing payment information of the user.

57. A method of shopping and promoting products on media, including the steps of:
a user playing media and accessing a store section on a user system having a user interface;
software recognizing and assigning functional tags to purchasable items in the media, the functional tags not being visually displayed on a screen during media playback, the items being promoted by a company that is partnered with the user system instead of a competitor;
the user selecting an item in the media for purchase;
the user accessing a one-click purchase function in the user interface; and
the user purchasing the item seamlessly using stored payment and address information securely stored on non-transitory computer-readable media within the user system.
